(19) United States
(12) Patent Application Publication
(10) Pub. No.: US 2003/0043003 A1
(43) Pub. Date: Mar. 6, 2003

(54) Magnetically latching microrelay

(76) Inventors: Karl E. Vollmers, Crystal, MN (US); Susan Bromley, Bloomington, MN (US); Arunkumar Subramanian, Plymouth, MN (US); Bradley J. Nelson, North Oaks, MN (US); Kamal Mothilal, Minneapolis, MN (US)

Correspondence Address: MERCHANT & GOULD PC, P.O. BOX 2903, MINNEAPOLIS, MN, 55402-0903, US

(21) Appl. No.: 09/943,907

(22) Filed: Aug. 31, 2001

(51) Int. Cl. H01H 51/22

(52) U.S. Cl. 335/78

(57) ABSTRACT

A microrelay device is described including a substrate with a first pair of contacts, a ferromagnetic material and a conductive coil surrounding the ferromagnetic material. The microrelay also includes an actuator having a permanent magnet and a contact area. The actuator is fixed at a first end and movable between a first position and a second position. The contact area of the actuator is spaced from the pair of contacts on the substrate in the first position and in contact with the first pair of contacts on the substrate in the second position. A method of fabricating a microrelay device is also described including forming a conductive coil embedded in an insulating material.

### FIELD OF THE INVENTION

The invention is directed to a microrelay and a method for fabricating a microrelay, more particularly to a microrelay including a magnet and having two stable positions.

### BACKGROUND OF THE INVENTION

Miniaturized relays are known, including individual components such as a magnetic circuit, an excitation coil, contacts, and a permanent magnet. These components have traditionally been assembled using high-performance robots. However, with the increasing development and use of integrated circuits, there is a need to further reduce the dimensions of electromagnetic relays so that they are on the same scale as integrated circuits. In addition, fabrication techniques associated with integrated circuits allow economies of scale, precision, and matching capabilities that are unparalleled in conventional relay assembly. Microelectromechanical systems (“MEMS”) have recently been developed as alternatives for conventional electromechanical devices such as relays, actuators, valves and sensors.

MEMS relays having improved isolation, breakdown voltage, and contact-to-contact resistance are needed. In addition, it is advantageous to have a relay that is bi-stable, that is, does not require electrical power to maintain the relay in its various switch positions, but merely uses power to actuate the relay between the positions.

U.S. Pat. No. 6,084,281 to Fullin et al. describes a planar magnetic motor and microactuator including magnetic poles and conductive coils that form a magnetic circuit with an air gap. A mobile contact-equipped mechanical element moves to selectively close or open the magnetic circuit. However, simpler and more efficient arrangements for a magnetically latching microrelay are desired.

### SUMMARY OF THE INVENTION

In one aspect of the present invention, a microrelay device includes a substrate having a first pair of contacts, a ferromagnetic material, and a conductive coil surrounding the ferromagnetic material. The microrelay device also includes an actuator that in turn includes a permanent magnet and a contact area. The actuator is fixed at a first end and is movable between a first position and a second position. The contact area of the actuator is spaced from the pair of contacts on the substrate in the first position and in contact with the first pair of contacts on the substrate in the second position.

In another aspect of the present invention, the conductive coil of the microrelay device is configured to selectively increase or decrease a local force on the actuator to allow movement of the actuator between the first and second positions, and the permanent magnet provides a latching force to hold the actuator in the second position.

In another aspect of the present invention, the actuator is configured so that a deflection force acts to return the actuator device to the first position from the second position.

In another aspect of the present invention, the ferromagnetic material of the substrate may be a permanent magnet.

In another aspect of the present invention, the actuator device is configured to move from the first position to the second position when the local magnetic force on the actuator is increased by applying current to the conductive coil in a first direction so that the local magnetic force is greater than the deflection force. The actuator device is configured to move from the second position to the first position when the local magnetic force on the actuator is decreased by applying current to the conductive coil in a second direction so that the deflection force is greater than the local magnetic force.

In another aspect of the present invention, a microrelay device includes a substrate having a ferromagnetic material, a conductive coil embedded within layers of insulating material, the conductive coil surrounding the ferromagnetic material, and a first pair of contacts on an exposed surface of the substrate, wherein current applied to the conductive coil selectively increases or decreases a local magnetic field. The microrelay device further includes an actuator movable between a first and second position and having a permanent magnet and a conductive contact area for contacting the first pair of contacts on the substrate when the actuator is in the second position. A deflection force acts to return the actuator to the first position when the local magnetic force is decreased by applying current to the conductive coil.

In another aspect of the present invention, the microrelay further includes a ground plane and the contact bar of the actuator contacts the ground plane when the actuator is in the first position or non-contact position.

In another aspect of the present invention, the microrelay has two contact positions and includes a top contacts substrate including a first pair of top contacts. The actuator according to this aspect of the invention further includes a top contact area. The top contact area of the actuator contacts the first pair of top contacts when the actuator is in the first position.

According to another aspect of the present invention, a method of fabricating a microrelay includes constructing an electromagnetic substrate and attaching an actuator beam structure to the electromagnetic substrate. Constructing an electromagnetic substrate includes the steps of forming a conductive coil, a current control line and a current return line embedded in an insulating material, etching away the insulating material in a center area of the coil, placing a magnet within the center area, and creating contact lines above the magnet. The actuator beam structure includes a magnetic material and a conductive contact area in a second end of the actuator, wherein the second end of the actuator is movable between a first position spaced from the contact lines and a second position contacting the contact lines.

### BRIEF DESCRIPTION OF THE DRAWINGS

The invention may be more completely understood by considering the detailed description of various embodiments of the invention which follows in connection with the accompanying drawings.

FIG. 1 is a cross-sectional view of a magnetically latched MEMS relay of the present invention, shown in an OFF, or non-contact, position.

FIG. 2 is a cross-sectional view of a magnetically latched MEMS relay of the present invention shown in an ON, or contact, position.

FIG. 3 is a top plan view of a layout of multiple relays according to the present invention.

FIG. 4 is a table of coil design parameters for coils having an effective current of 57.6 Amps.

FIGS. 5-14 are cross-sectional views of a substrate portion of the microrelay of FIG. 1 during assembly steps.

FIG. 15 is a top plan view of a partially assembled substrate portion of the microrelay of FIG. 1 at the step illustrated in FIG. 14.

FIG. 15A is a top plan view of another embodiment of a partially assembled substrate portion of the microrelay of FIG. 1 at the step illustrated in FIG. 14.

FIG. 16 is a cross-sectional view of the substrate portion of the microrelay of FIG. 1.

FIG. 17 is a cross-sectional view of an actuator wafer of the microrelay of FIG. 1 during assembly.

FIG. 18 is a top plan view of the actuator wafer of FIG. 17.

FIG. 19 is a cross-sectional view of an actuator wafer of the microrelay of FIG. 1 during assembly.

FIG. 20 is a top plan view of the actuator wafer of FIG. 19.

FIG. 21 is a cross-sectional view of the actuator wafer of FIG. 1 during assembly.

FIG. 22 is a top plan view of the actuator wafer of FIG. 21.

FIG. 23 is a cross-sectional view of the actuator wafer of the microrelay of FIG. 1 during assembly.

FIG. 24 is a top plan view of the actuator wafer of FIG. 23.

FIG. 25 is a cross-sectional view of the actuator wafer of the microrelay of FIG. 1 during assembly.

FIG. 26 is a bottom plan view of the actuator wafer of FIG. 25.

FIG. 27 is a cross-sectional view of an actuator wafer of the microrelay of FIG. 1 during assembly.

FIG. 28 is a bottom plan view of the actuator wafer of FIG. 27.

FIG. 29 is a cross-sectional view of an actuator wafer of the microrelay of FIG. 1 during assembly.

FIG. 30 is a bottom plan view of an actuator wafer of FIG. 29.

FIG. 31 is a cross-sectional view of a second embodiment of a microrelay having a ground contact plane.

FIG. 32 is a cross-sectional view of a third embodiment of a magnetically latching microrelay having two contact positions.

FIG. 33 is a force-distance plot of the deflection of the cantilever arm plotted against the force on the arm.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE EMBODIMENTS

The present invention is believed to be applicable-to a variety of systems and arrangements for microrelays. The invention has been found to be particularly advantageous in application environments where a switch is needed for an electrical connection, such as in telecommunications. While the invention is not so limited, an appreciation of various aspects of the invention is best gained through a discussion of various application examples operating in such an environment.

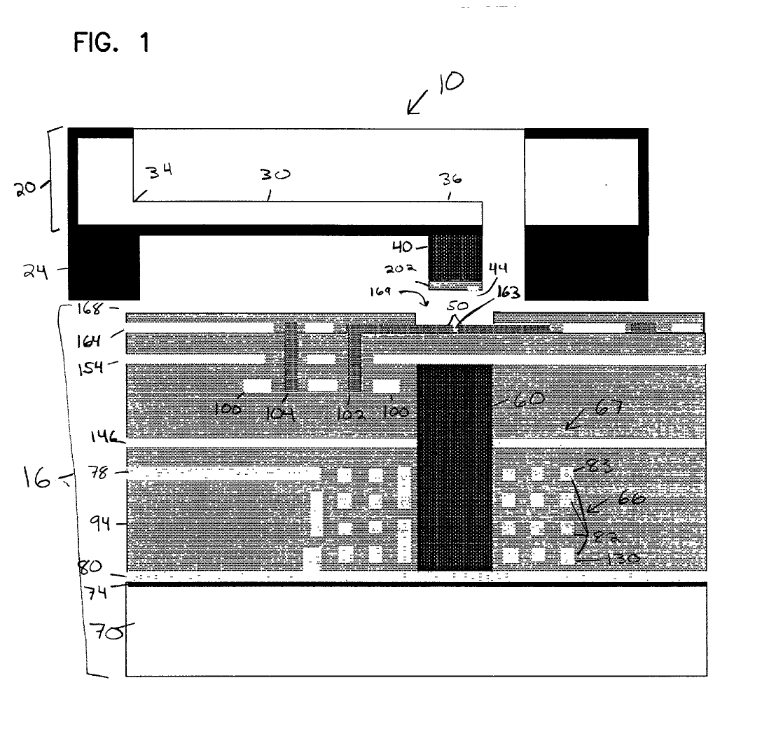

FIG. 1 illustrates a cross-sectional view of one particular embodiment of a microrelay 10 according to a preferred embodiment of the present invention. The microrelay includes a substrate 16, an actuator 20 and a spacer 24 between the substrate 16 and the actuator 20. The actuator 20 includes an actuator arm or cantilever arm 30 that is fixed at a first end 34 and is spaced from and suspended over the substrate 16 at a second end 36 in a non-contact position illustrated in FIG. 1. The actuator arm 30 includes a permanent magnet 40 and a conductive contact area 44 near its second end 36.

In the non-contact position of FIG. 1, the contact area or contact bar 44 is spaced from the substrate 16. The actuator arm 30 may extend parallel to the substrate 16 in the non-contact position, as illustrated in FIG. 1. However, it is likely that the actuator arm 30 may be somewhat deflected toward the substrate 16 in the non-contact position due to the influence of the permanent magnet 40. The substrate 16, or contacts substrate 16, includes a pair of contacts 50 that are separated by a gap 163 that may be closed by the contact bar 44. The substrate 16 also includes a ferromagnetic material 60 that is surrounded by a conductive coil 66 to form an electromagnet 67. The ferromagnetic material 60 is preferably a magnetic material, such as a permalloy or another material with high susceptibility. The ferromagnetic material may have soft or hard magnetic characteristics. Individual layers 82 of the conductive coil 66 are spaced throughout a dielectric polymer material 94 in the substrate 16. Alternatively, the actuator 30 may include a ferromagnetic material in place of a permanent magnet 40 while the substrate 16 includes a permanent magnet as the core 60.

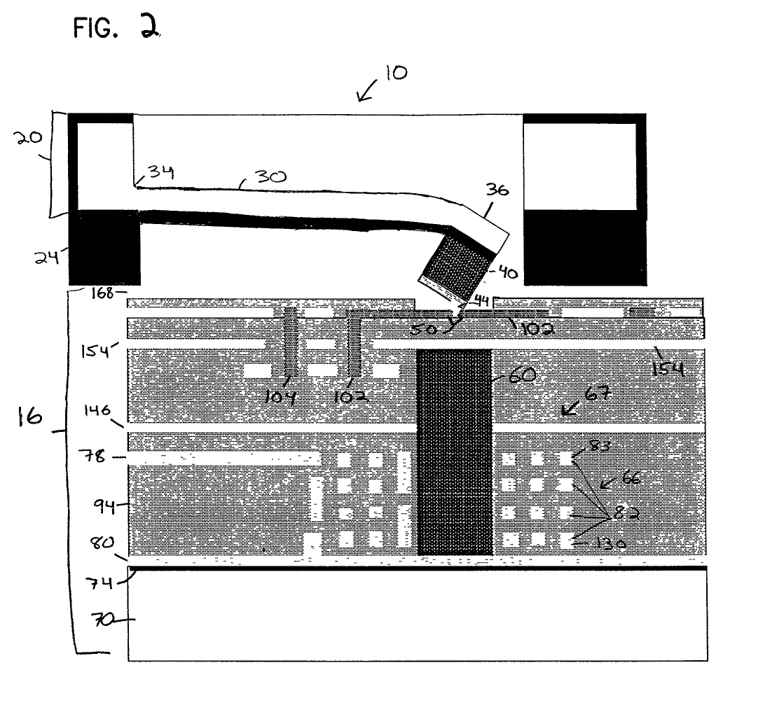

FIG. 2 illustrates a contact position of the actuator 30, where the actuator 30 is deflected toward the substrate 16 and the contact bar 44 makes contact with and joins a first pair of contacts 50. In the contact position illustrated in FIG. 2, the cross bar 44 is diagonally oriented. However, the cross bar may be arranged in many different positions and orientation, such as having a horizontal surface in the contact position, as long as it touches the contacts 50 in the contact position. In the relay of FIG. 1, the non-contact position is an OFF position where there is a gap 163 between the two contacts 50 on the substrate 16. Conversely, the contact position shown in FIG. 2 is an ON position.

An alternative embodiment is depicted in FIG. 31 where an A-type relay 300 is provided with a connection to ground in the OFF position. In FIG. 31, many of the components are the same as the microrelay 10 of FIG. 1, where identical reference numbers are used to indicate similar parts. Microrelay 300 includes a ground plane 305 above the actuator 330. The actuator 330 includes a dielectric layer 302 that wraps around to the top side of the actuator 330. The contact bar or bars 344 also extend over the dielectric layer to the top where they may contact the ground plane 305 in the OFF or “non-contact” position, thereby increasing isolation between the contact bar and the contacts.

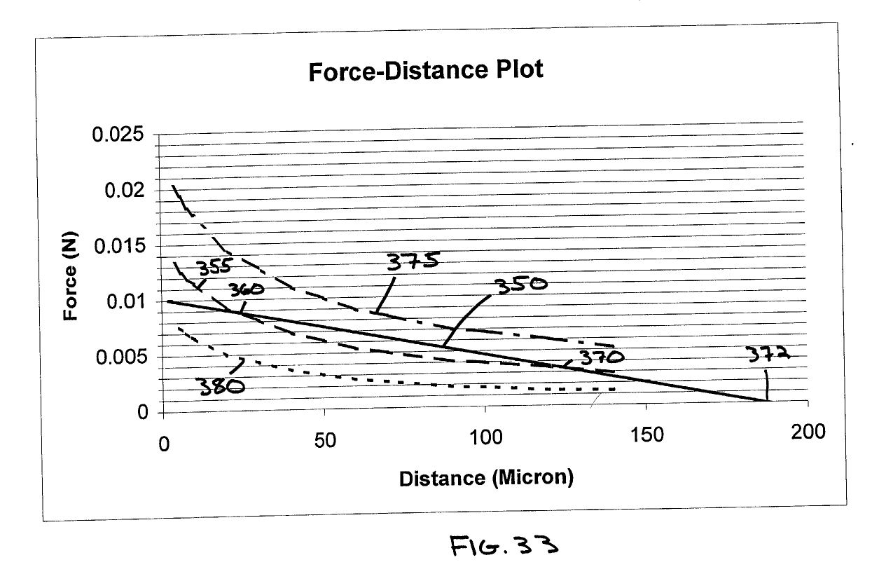

It is also possible to apply the principles of microrelay 10 to a C-type relay having two contact or ON positions. FIG. 32 illustrates a bi-stable, magnetically latching C-type relay 400 according to one embodiment of the present invention. Many of the components of the microrelay of FIG. 32 are similar to the components of the microrelay of FIG. 1 and identical references numbers indicate these similar parts.

The C-type microrelay 400 includes an actuator substrate 420 that has an actuator arm 430 that can move between a first contact position and a second contact position. The actuator arm 430 is illustrated in the first contact position in FIG. 32, where the actuator arm is in contact with a top substrate 440. The top substrate 440 includes an upper pair of contacts 442. To form an electrical connection between the upper pair of contacts 442, the actuator arm 430 includes a top contact bar 440 and a top dielectric layer 448. When the actuator arm 430 is in the second contact position, it will be deflected downward toward the contacts substrate 16 with contact bar 44 touching contacts 50, similar to the deflected position shown in FIG. 2 for A-type microrelay 10.

The actuator 430 may be configured to be in a somewhat deflected position when in contact with the top contacts 442. In this situation, the restoring force of the actuator 430 pushes the actuator 430 against the top contacts 442, thereby decreasing the contact resistance between the top contact bar 440 of the actuator 430 and the top pair of contacts 442.

The cantilever arm 30, 330 or 430 is actuated to move between the ON and OFF positions, or between the first and second contact positions, by magnetic and electromagnetic forces acting on the permanent magnet 40. For simplicity, the process of moving the actuators 30, 330 and 430 will be discussed with reference to actuator 30 of FIGS. 1 and 2. The same principles apply to the movement of actuators 30, 330 and 430.

A local magnetic field is produced by the permanent magnet 40 within the actuator. An electromagnetic field can be produced to assist or retard the local magnetic field of the permanent magnet 40 by passing current through the conductive coil 66 within the substrate 16. When a current passes through the coil 66 in one direction, the electromagnetic field produced amplifies the field of the permanent magnet, and the cantilever arm is drawn toward the stationary electromagnet. The electrical contacts 50 are then closed by the contact bar or area 44 of the actuator 30. Once the actuator is in contact with the substrate 16, the electromagnet may then be turned off by discontinuing the current through the conductive coil 66. The contact area 44 of the actuator remains in contact with the first pair of contacts 50, latched by the magnetic force of the permanent magnet, as shown in FIG. 2.

To unlatch the relay 10, current is applied to the conductive coil 66 in a reverse direction and the resulting field repulses the permanent magnet in the actuator to the point where the restoring force of the deflected actuator beam 30 combined with the repulsive force of the coil is greater than the attractive magnetic force exerted by the actuator's permanent magnet. The actuator 30 then moves away from the electromagnet 67 thereby breaking contact with the contacts 50 on the substrate 16.

Magnetic, electromagnetic and deflection forces need to be considered in designing the microrelay. The magnetic field generated by the permanent magnet 40 in the actuator draws the actuator to the ferromagnetic material 60 of the substrate 16. The force felt by the actuator due to the magnetic field of the permanent magnet 40 is inversely dependent on the square of the distance between the magnetic material 40 of the actuator and the core 60 of the substrate. In the non-contact position, the force of the magnetic field of the permanent magnet will not be large enough to overcome the deflection force of the actuator arm to move the actuator into the contact position. The force required to move the cantilever beam depends linearly on deflection distance. Deflection distance is the distance that the second end 36 of the actuator arm 30 is displaced from the horizontal plane.

FIG. 33 is a graph of force versus distance showing the forces acting on the actuator 30 at various distances from the magnet 60 of the substrate 16. Plotted along the horizontal axis is distance in microns, and plotted along the vertical axis is force in Newtons. At the origin the force and distance are zero. The distance from the actuator to the electromagnet is at its smallest value when the actuator is in the contact position shown in FIG. 2 and at its largest value when the actuator is in an undeflected position, as shown in FIG. 1. The graph of FIG. 33 shows the forces on an actuator in an embodiment of the microrelay where the actuator 30 includes a permanent magnet 40, where the core 60 of the electromagnet 67 is permalloy, and where a permanent magnet is present in a base portion of the substrate 16.

The solid line 350 shows the linear cantilever return force for the range of positions of the cantilever arm. Where the actuator is as close as possible to the magnet 60, the cantilever return force is at its highest value. When the actuator is in an undeflected or horizontal position, the cantilever return force is zero, as shown at point 372. Curve 355 shows the magnetic force on the actuator when no current is applied to the conducting coil 66. At the points 360 and 370 where the solid line 350 and a curve 355 intersect, the deflection force is equal to the magnetic force on the actuator 30. At point 360 the arm is about 30 microns from the magnet 60 and the cantilever force is equal to the magnetic force on the arm. Point 360 corresponds to the contact position. Therefore, in this embodiment of the present invention, the contact position is where the actuator is less than about 30 microns from the magnet 60.

At point 370 the cantilever return force and the magnetic force are also equal, where the cantilever is about 150 microns from the magnet 60. Point 370 corresponds to the non-contact position. Therefore, in this embodiment the non-contact position is where the actuator is about 150 microns or more from the magnet 60.

Point 372 is where the cantilever return force 350 intersects the distance axis, where the return force is zero. Point 372 represents the position of the actuator in the undeflected state. The actuator is about 175-180 microns from the magnet 60 in the undeflected state in this particular example.

Curve 375 of FIG. 33 illustrates the magnetic force upon the actuator arm where the force of the permanent magnet 40 and magnetic material 60 is increased by an electromagnetic field created by passing current through coil 66. For all actuator arm positions, the magnetic force illustrated in curve 375 is greater than the cantilever return force of line 370, so that the arm will be drawn into contact with the substrate. Curve 380 illustrates the magnetic force acting upon the actuator arm where the electromagnetic coil is used to create a magnetic field that repulses the actuator arm. For all deflection distances, curve 380 is less than the cantilever return force shown in line 350, so that the arm will pull away from the substrate.

The data presented in FIG. 33 illustrates the forces for one embodiment of the microrelay of the present invention, where the ferroelectric material 40 at the second end 36 of the actuator arm 30 is a permanent magnet, where the core 60 of the electromagnet is a permalloy core of about 1 millimeter diameter and about 100 microns thick, surrounded by a coil that is six layers high having 40 turns in each layer. The forces illustrated in FIG. 33 assume that the current coil is driven at plus or minus about 57.7 Amps effective current with a potential of about 58.2 Volts, where coil resistance is about 442 ohms, although these specific values are not required for operation. This particular configuration provides approximately three milli-Newtons of contact force and approximately one milli-Newton of breaking force.

The contact force is the difference between the cantilever return force (line 370) and the magnetic force on the actuator at the point where the cantilever arm contacts the substrate. The value of the contact force is limited by the rate at which the magnetic force increases at small separations and the ability of the electromagnet to reduce the magnetic field to unlatch the relay. Although the contact force should be maximized, the cantilever return force cannot be reduced too much or it will be smaller than the reduced magnetic field and the relay will fail to unlatch. Preferably the microrelay will provide a contact force of about 0.1 to 12 milli-Newtons,. more preferably about 0.2 to 10 milli-Newtons, most preferably about 10 milli-Newtons.

Another consideration is the provision of a breaking force. It is possible that the contact area of the actuator arm and the contacts on the substrate may weld during contact requiring substantial forces to open the contacts. High breaking forces may only be achieved at the expense of lower contact forces. By maximizing the changes in force caused by the electromagnet, the force needed to make and break the contact will be sufficient. Preferably the microrelay will provide a breaking force of about 0.5 to 5 milli-Newtons, more preferably about 1-2 milli-Newtons.

The microrelay embodiment of the Figures has the potential to produce several milli-Newtons of force to make and break contacts which will ensure long life and sufficient contact resistance. In a preferred embodiment, the actuator arm 30 is sufficiently wide so that two contact bars 44 may be provided at the second end of the actuator 30, so that two circuits can be closed with one relay. For example, both tip and ring circuits in a telecommunications context may be closed using the microrelay 10.

The contact resistance between the pair of contacts 50 when closed by the contact area 44 is preferably minimized, both when current increases the magnetic field and when no current is applied to the coil. Where the contact 50 and contact area 44 are made of gold, the contact resistance is preferably about 50 to 150 milliohm. The insulation resistance of the microrelay is preferably at least about 10¹² ohm, more preferably at least about 10¹⁵ ohm.

Structure of Contacts Substrate

The structure of the contacts substrate 16, where the core 60 and coil 66 are located, will now be discussed in further detail with reference to FIG. 1. The Figures are not drawn to scale in order to clearly illustrate very small features. The substrate 16 includes a substrate base 70.

The substrate base should be made of a material that is relatively easy to work with while forming the various layers of the substrate and that is not damaged by any of the processing steps for forming the layers. Preferably, the substrate base 70 is an iron substrate. The presence of a ferromagnetic material such as iron as the base 70 will provide the advantage of increased field strength. It is also possible for the substrate base 70 to be a silicon wafer. For a silicon substrate base, an insulating layer 74 may be present, such as silicon oxide produced in an oxidizing furnace. The substrate 16 also includes a conductive coil 66 which is made up of a coil control line 78, layers of coil 82 and a current return line 80. The topmost layer 83 of coil is constructed such that the current spirals in toward the center of the coil. The inward or outward nature of the coil direction switches with alternating layers so that the current travels in the same direction for all coil layers. Where the substrate base 70 is iron or another conductive material, the current return line 80 may be eliminated and the substrate acts as the grounded return line.

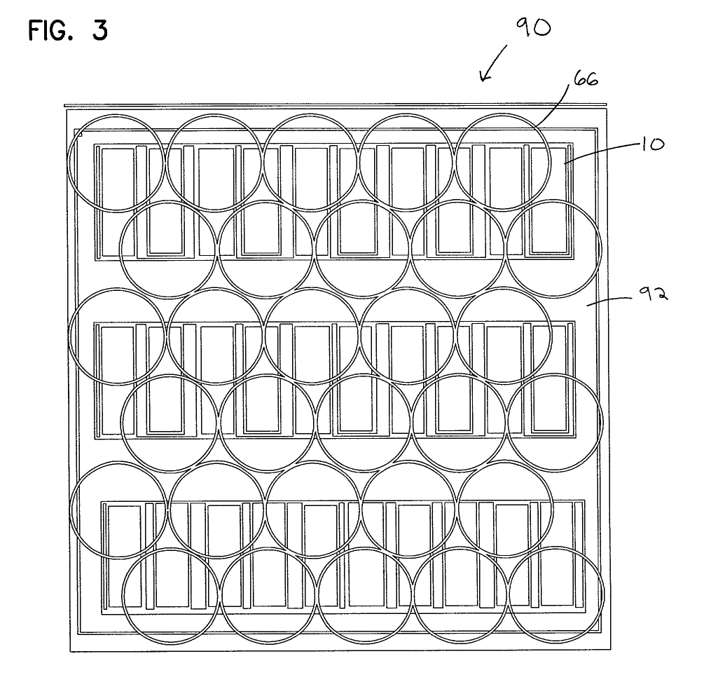

The size and performance of the conducting coil 66 has direct results on the performance of the device. To create the forces needed to actuate the relay, the coil must have several turns. However, cost and size considerations indicate a small coil footprint and a minimal number of layers. In one preferred embodiment, a diameter for the coil is about 2.7 millimeters. This coil diameter allows fabrication of six rows of six coils on a 0.6×0.6 inch chip 92. In a second preferred embodiment, a coil diameter of 3.2 millimeters allows for six rows of five coils each on a chip 92 measuring 0.6×0.6 inch. FIG. 3 illustrates a relay layout 90 including six rows of six coils each and providing for 30 microrelays 10.

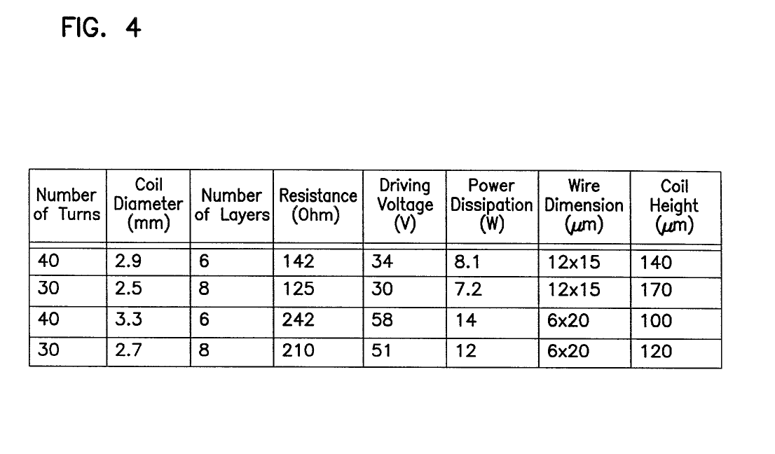

Many factors need to be considered in constructing a microrelay 10 in addition to the number of turns in each coil layer, the number of coil layers, and the coil diameter. For example, the minimum wire size and wire spacing is also important, along with wire resistance. Wire resistance increases as the size of the wire decreases. The spacing between wires is a function of processing control and depends on the manufacturing process that is employed. The table of FIG. 4 illustrates several possible coil design parameters for coils having an effective current of 57.6 amps and assuming wire separation of 10 micrometers between coil layers and between coil turns. Preferably, the microrelay 10 includes 6-8 coil layers 82, where each coil layer includes 30-40 turns. Each turn preferably consists of a wire with dimensions of about 4 to 30 microns, more preferably about 6 to 15 microns. Each turn and each layer is preferably separated by about 5 to 15 microns of insulating material, more preferably about 10 microns of insulating material.

The conductive coil 66 is encased within a dielectric polymer material 94. The dielectric polymer 94 should provide electrical insulation and preferably has good mechanical properties. In addition, it is preferred that the dielectric polymer 94 result in planarization as it is deposited upon other layers, such as the conducting coils. Preferably, benzocyclobutene (BCB) is the material used for the dielectric polymer. BCB is a silicon containing a cross-linking polymer that has good planarization and mechanical properties and is available under the trade name Cyclotene™ from DuPont.

The substrate 16 also includes metallic ground plane layers 146, 154, 164 and 168 which provide a shielding function. Ground wires 100 are also present within the substrate 16. A first conductor line 102 and a second conductor line 104 are also present in the substrate 16 and are broken at the contact point for the actuator 30. The first pair of contacts 50 for the first conductor 102 are shown in FIG. 1, while the second pair of contacts for the second conductor 104 are not shown in FIG. 1.

Fabrication of the Substrate

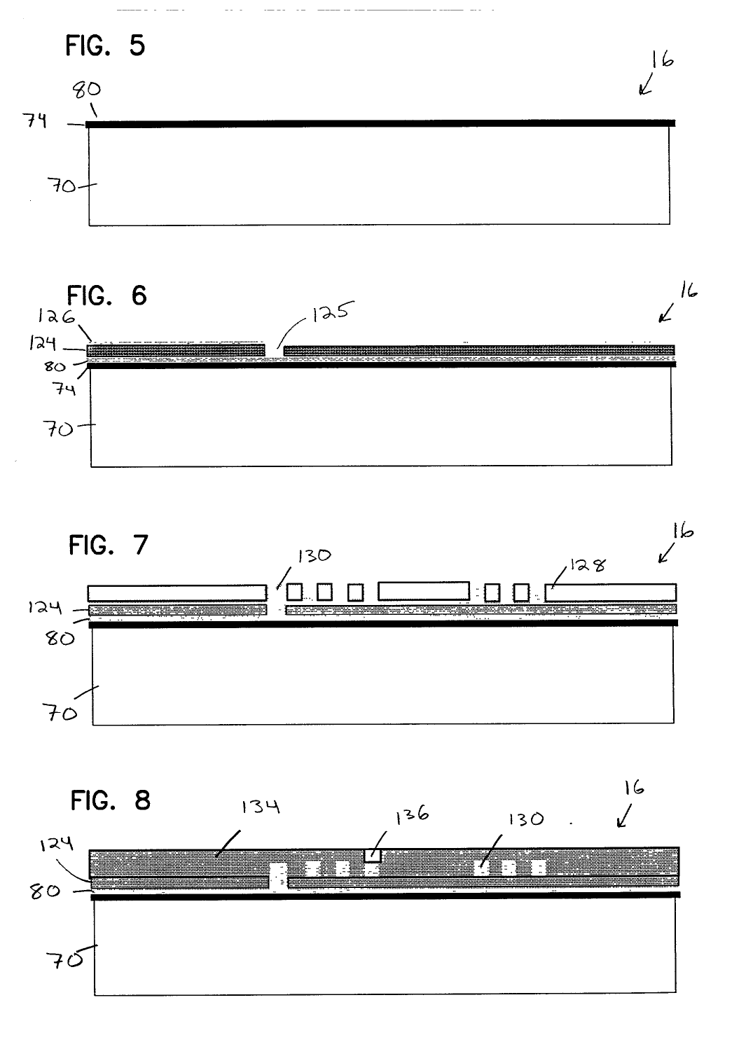

Now referring to FIGS. 5-16, the fabrication of the substrate 16 will be described. The substrate base 70 is first provided with an optional insulating layer 74 as shown in FIG. 5. Then a seed and adhesion layer (not shown) is deposited, such as a thin layer of titanium or chrome followed by a thicker layer of copper which may be deposited using a radio frequency sputterer. After the seed and adhesion layer, the current return layer 80 is formed of a conductive material. The current return layer may be made of copper with a thickness of about 5 micrometers using an electroplating technique, although other materials, thicknesses and formation techniques are possible. Most preferably, the current return layer 80 and the coil layers 82 are formed of copper using electroless plating which leads to a more uniform plating thickness. For convenience, throughout the discussion of the fabrication of the substrate 16, conductive layers such as current return layer 80 and other layers will be referred to as being made of copper although other materials are possible.

A layer of dielectric polymer 124 is then formed. As discussed above, BCB is the preferred material used for the dielectric polymer layers of the microrelay 10. For convenience, the fabrication process for forming the microrelay 10 will be discussed assuming that BCB is used as a dielectric polymer. However, many other materials are possible for the dielectric polymer used in the microrelay of the present invention. Dielectric polymer or BCB layer 124 is preferably about 5 micrometers thick and is spun onto the wafer, exposed, developed, plasma cleaned, and then baked. The exposure and development steps are used to create openings in the BCB layer to the copper layer below. These openings, such as opening 125 in FIG. 6, will serve to connect the electroplated copper layer 80 to the coil so that the copper layer 80 may serve as a current return for all coils on a particular die.

The baking step may take place either in a conventional N₂ purged oven, for example at a temperature of about 250° C., an infrared rapid thermal annealer, or a belt-fed infrared furnace. The substrate base and the layers upon it must be protected from ambient oxygen, no matter what the baking technique, to prevent surface oxidization of the BCB. Typically, when metals are deposited upon BCB, a seed and adhesion layer such as titanium or chrome and copper is applied. However, when BCB is applied over a metal, the seed and adhesion layer is not used.

FIG. 6 shows the BCB layer 124 and a seed and adhesion layer 126. The seed and adhesion layer 126 may include a thin layer of titanium or chrome followed by a thicker layer of copper. Now referring to FIG. 7, following the deposition of the seed layer 126 an application of photo resist 128 is patterned for forming the first layer of coils. The photo resist 128 may have a thickness of about 15 micrometers for this layer, and for many other layers of photo resist used during assembly. Then, a first copper layer 130 is deposited for the coil on the portions of the substrate not covered by the photo resist 128 as shown in FIG. 7. Although each layer of coils is shown in the Figures to have four turns for simplicity, a preferred embodiment of the present invention will have about 20-50 turns in each layer, more preferably about 30-40 turns. After the first copper layer 130 is formed, the photo resist 128 is then stripped. For the areas not covered by the first copper layer 130, the seed and adhesion layer 126 is then removed. The copper portion of the seed and adhesion layer is removed by ion milling and the titanium or chrome portion is removed by dipping in fluroboric acid or by continued ion milling.

As shown in FIG. 8, a BCB layer 134 is again spun on the wafer and an opening 136 is patterned in the BCB layer 134 to allow connection between the first and second layers of coils. The steps illustrated in FIGS. 6-8 are repeated until a total of 6 to 8 layers of coils are deposited. Only four layers of coils are illustrated in the Figures for simplicity. The substrate is planarized several times with each layer of BCB during the process which provides a smooth surface for photolithography.

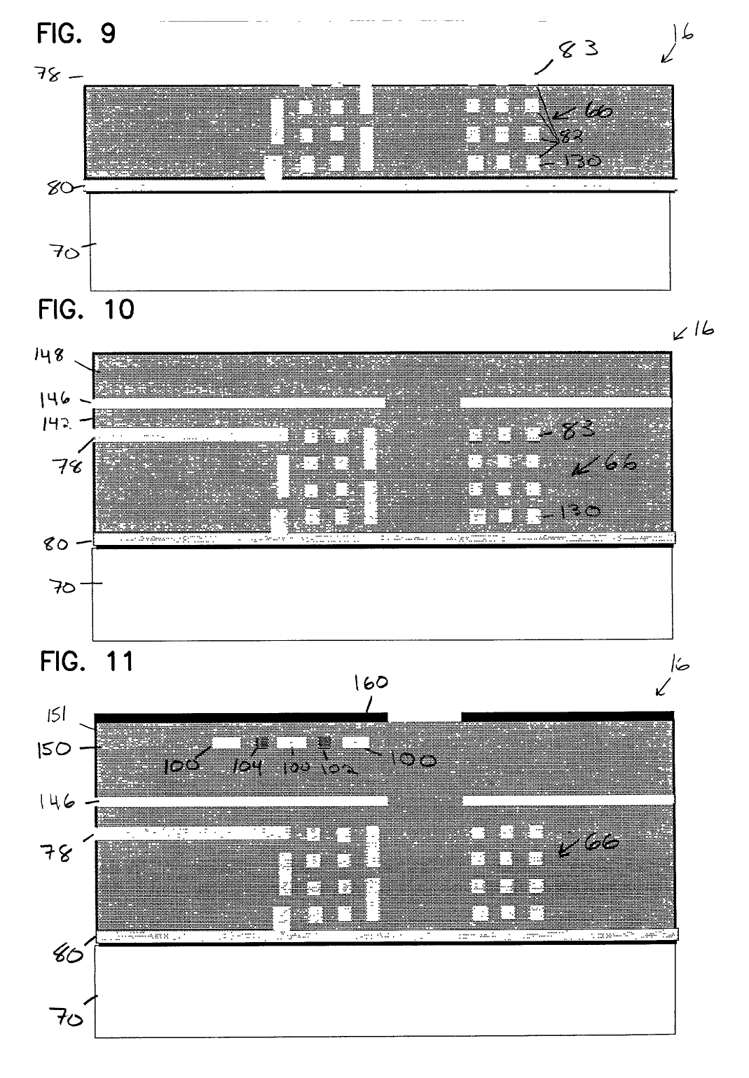

Now referring to FIG. 9, a last layer of the coil 83 is plated such that it connects to a current control line 78 at an outermost turn and connects to the layer below at an innermost turn. Now referring to FIG. 10, the top layer 83 of the coil 66 and the current control line 78 are then covered with a BCB layer 142 and a metal shielding layer 146. An additional layer of BCB 148 is added to the construction. Preferably, the contacts substrate 16 at this point in assembly has a thickness of about 90 micrometers.

As shown in FIG. 11, ground wires 100, a first conductor line 102 and a second conductor line 104 are formed on the contacts substrate 16 embedded within a dielectric polymer such as BCB in layer. A further layer of BCB 151 is then deposited.

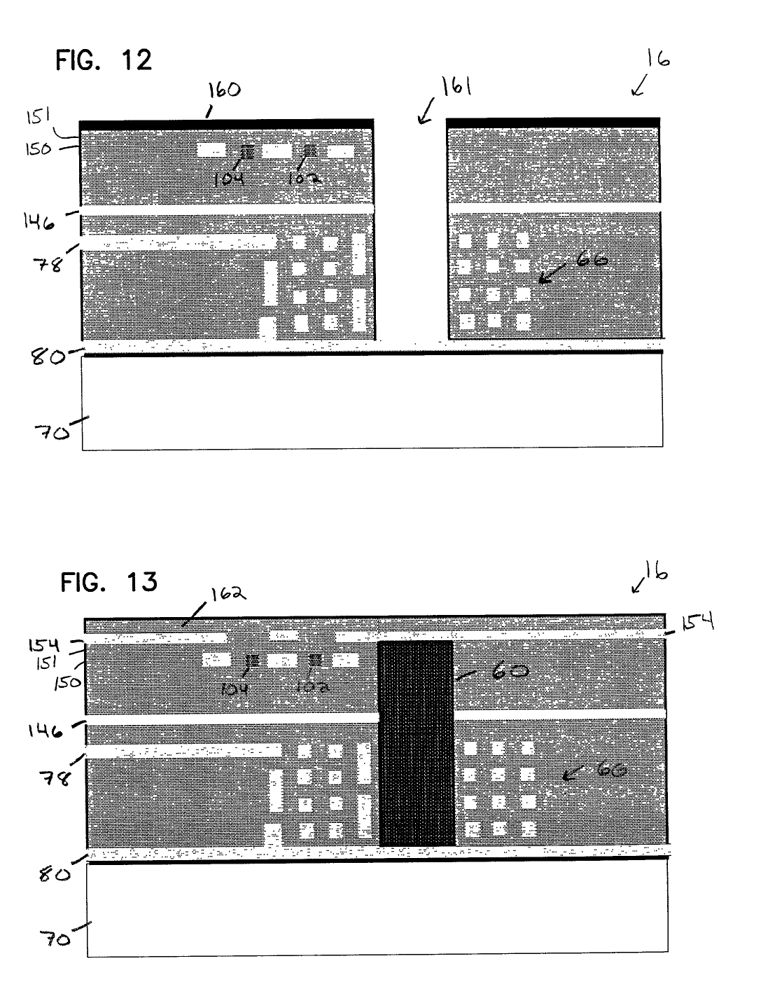

A hard mask 160, which is typically a metal material, is applied to the surface of the BCB layer 150 and patterned for the magnetic core. Now referring to FIG. 12, a reactive ion etch is then used, such as O₂ and SF₆ or CF₄, to form a hole 161 for the permanent magnet. Alternative techniques may also be used to form the hole 161 in the dielectric polymer.

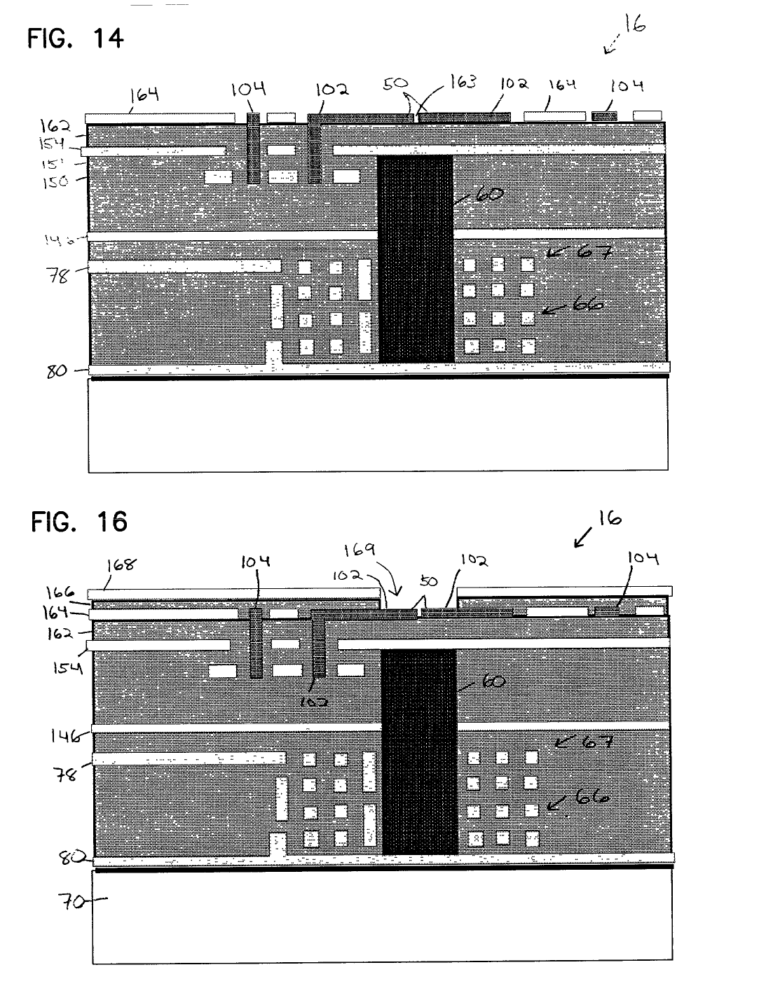

The hard mask 160 is then removed and the core 60 is formed as shown in FIG. 13. Many different alternatives exist for forming the core 60. For example, preferably, a permanent magnetic powder is mixed with epoxy and placed within the hole. Alternatively, a magnet may be machined and then placed within the hole. A further alternative is electroplating, followed by polishing to reduce the magnet to the appropriate level. For all formation techniques, steps are preferably taken to ensure a flat, level surface for deposition of signal lines, such as polishing using mechanical or chemical means.

Next a ground plane 154 is formed. The ground plane is patterned to include gaps for the conductor lines 102 and 104. A BCB layer 162 is then formed.

Now referring to FIG. 14, a second hard mask (not shown) is applied to produce the openings to the first conductor line 102 and the second conductor line 104 through layers 151, 154 and 162. A second reactive ion etch is used to create the openings. The hard mask is removed and a seed and adhesion layer (not shown) then forms the base for the conductive lines 102 and 104. Preferably, a low resistivity metal will be used for the first and second conductive lines. The conductive lines are patterned in photo resist and then plated. The ground plane 164 may also be patterned and plated. The resist is stripped and the seed adhesion layer is removed.

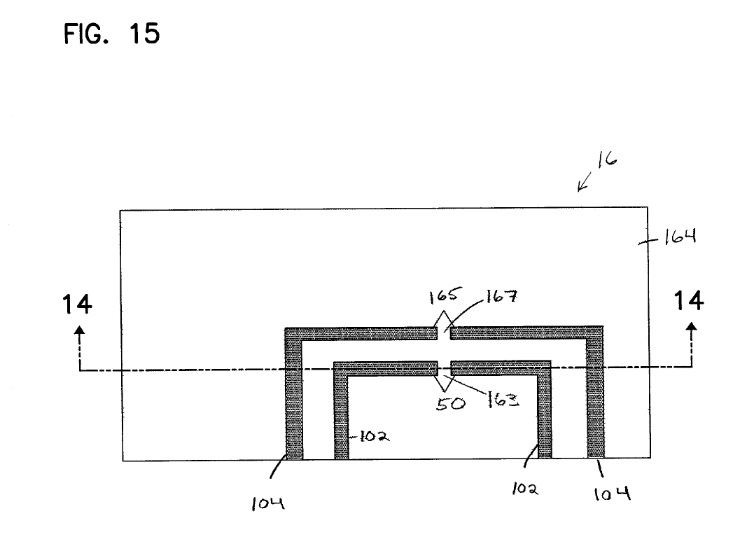

FIG. 15 is a top view of one embodiment of a contacts substrate during the assembly step illustrated in FIG. 14. FIG. 14 is a cross-sectional view of the substrate of FIG. 15 along line 14-14. FIG. 15 illustrates the first conductor line 102 and the second conductor line 104, each having a gap 163, 167 where the line is interrupted. The gap 163 in the first conductor line 102 creates a first pair of contacts 50. The gap 167 in the second conductor line 104 creates a second pair of contacts 165. The provision of two pairs of contacts 50, 163 on the contacts substrate 16 is useful because the microrelay 10 may then be used to close two relays simultaneously. Alternatively, microrelay 10 may be used to close only one relay line, or more than two conductive lines may be provided on the conductive substrate 16.

FIG. 15A is a top view of an alternate embodiment of a contacts substrate 16 during the assembly step illustrated in FIG. 14. FIG. 15A illustrates the first conductor line 102A and the second conductor line 104A, each having a gap 163A, 167A where the line is interrupted. The gap 163A in the first conductor line 102A creates a first pair of contacts 50A. The gap 167A in the second conductor line 104A creates a second pair of contacts 165A. The layout of conductor lines 102A, 104A differs from the layout of conductor lines in FIG. 15 because a portion of each conductor line is offset from a remainder of each conductor line so that the gaps are established in a vertical direction.

Now referring to FIG. 16, the contact lines are then coated in an additional layer of BCB 166 with an optional conductive ground plane 168 and additional BCB coating (not shown). An opening to the pad area of the coil wires and first and second conductor lines are then created through a variety of wet etch and reactive ion etching steps. Steps are taken to ensure that none of these steps harm the exposed contacts. For example, the contacts may be buried under a sacrificial material. The type of sacrificial material used depends on the ability to remove it without damaging the contacts.

Isolation between the pairs of contacts is dependent on the separation between the contacts. Preferably, the contacts are separated by at least 100 micrometers; more preferably by at least 150 micrometers; and most preferably by about 200 micrometers. The dielectric layer 162 immediately below the pair of contacts is preferably a dielectric with a low permitivity, for example less than 3. Preferably, the dielectric layer 162 is greater than about 5 micrometers; more preferably about 10 micrometers.

Structure of the Actuator

The material that forms the cantilever arm or actuator 20 should have appropriate deflection properties and sufficient fatigue resistance. Adjustment of the width, thickness and length of the actuator arm 20 can be used to achieve the desired beam stiffness and return force. Silicon is a preferred material for use as the substrate material for the actuator portion 30 because of its mechanical properties. Other materials having sufficient compliance, fatigue resistance, and compatibility with the processing steps may be used in place of silicon.

One example of an arm suited for use in the microrelay is an arm made of silicon and measuring 3,000 micrometers long, 1,000 micrometers wide, and 45 micrometers thick.

The actuator arm 30 is shown in a deflected, contact position in FIG. 2, where the contact area 44 is touching the contacts 50. In the embodiment illustrated in FIG. 2, the second end 36 of the arm 30 has rotated to some degree as a result of the magnetic forces and deflection forces acting upon the arm 30. As a result, the arm 30 is slightly bent. It is also possible for the actuator arm to have different configurations in the deflected, contact position. For example, the length of the arm 30 may be relatively straight extending diagonally from the first end 34 to a lower second end 36. In this configuration, the magnetic material 40 and the contact bar 44 may remain relatively horizontal in orientation. In this type of configuration, the contact bar 44 may be located near the center of the dielectric material 202. The thickness of the dielectric material 202 may be adjusted to accommodate the particular opening shape 169 for the contacts 50.

Fabrication of the Actuator

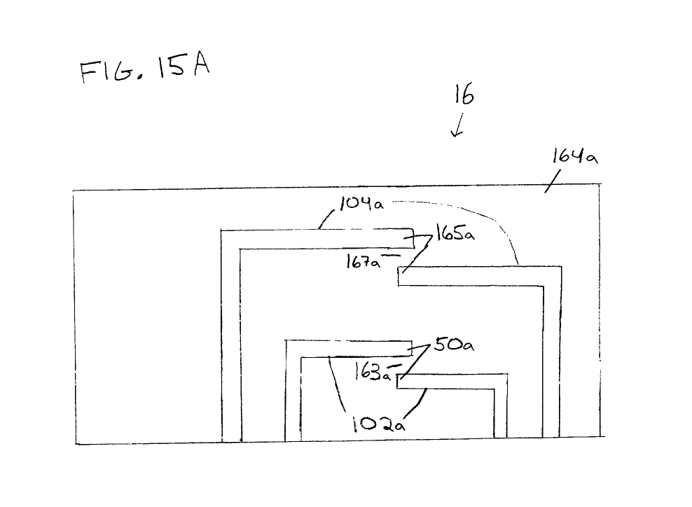

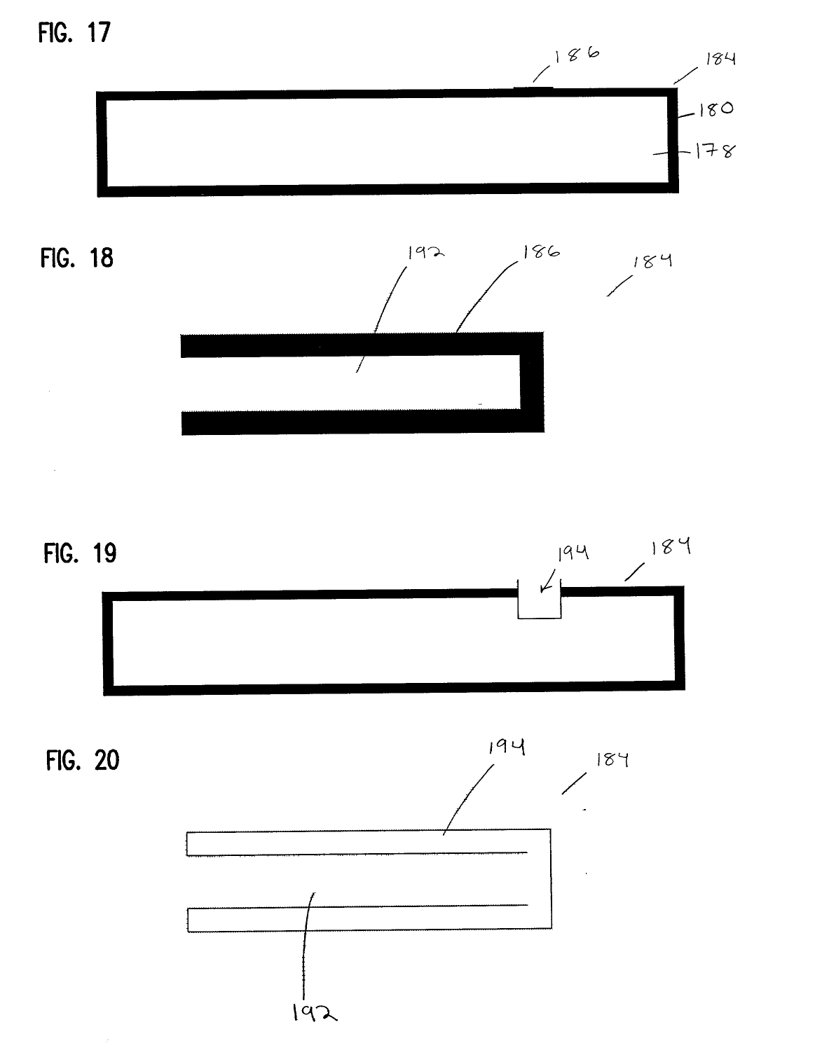

The actuator arm may be fabricated using the manufacturing steps shown in FIGS. 17-30 in one embodiment. As shown in FIG. 17, an actuator substrate 178, which is preferably a silicon wafer, is surrounded by a layer of silicon nitride 180. Preferably, the silicon nitride is deposited upon the actuator substrate 178 using a low pressure chemical vapor deposition technique. As shown in a cross-sectional view at FIG. 17, and in a top plan view at FIG. 18, a layer of photo resist 184 is applied, patterned and developed on one side of the actuator substrate 178 to prepare for etching an outline of the actuator arm. The photo resist 184 defines a trench 186 that surrounds the portion 192 of the substrate that will form the actuator arm.

As next shown in cross-sectional view in FIG. 19 and in top plan view at FIG. 20, the trench 194 is etched around the portion 192 that will form the actuator arm. The trench 194 is preferably about 50-100 micrometers deep and wide.

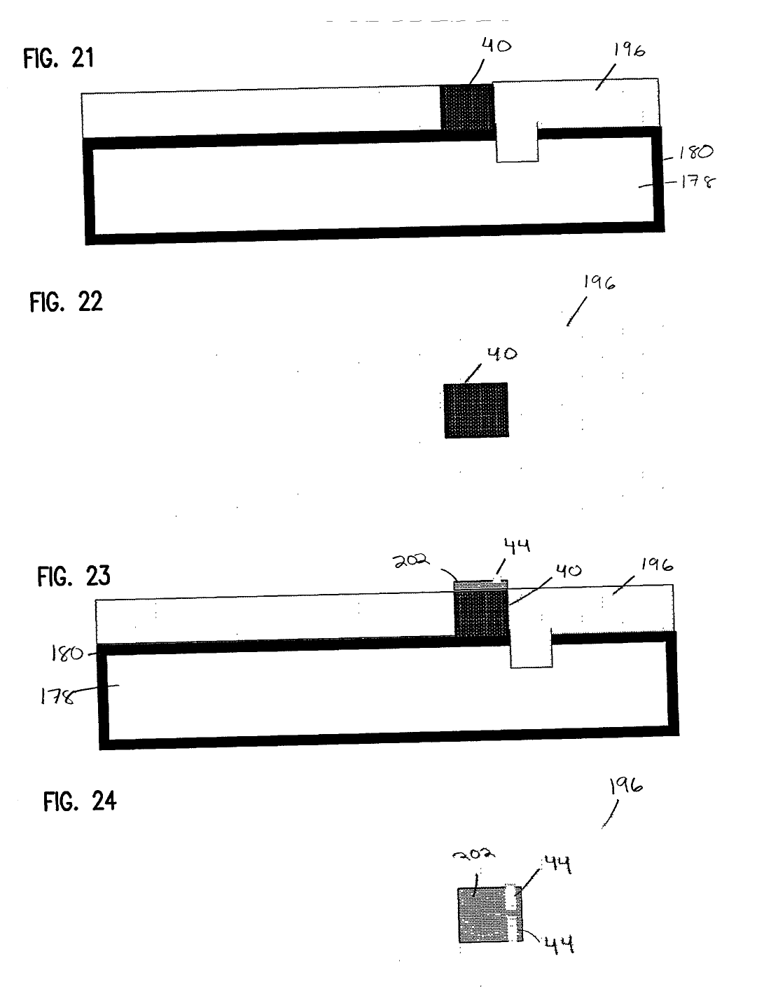

Now referring to cross-section FIG. 21 and top plan view FIG. 22, next, a seed and adhesion layer (not shown) is sputtered on the top surface of the actuator substrate 178. Then, several layers of photo resist 196 are applied to a thickness of greater than about 100 micrometers. A hard magnetic material, ferromagnetic material or permanent magnet 40 is then plated in the opening formed by the photo resist 196. This material may be formed using many methods known in the art, for example by the formation techniques discussed in relation to core 60.

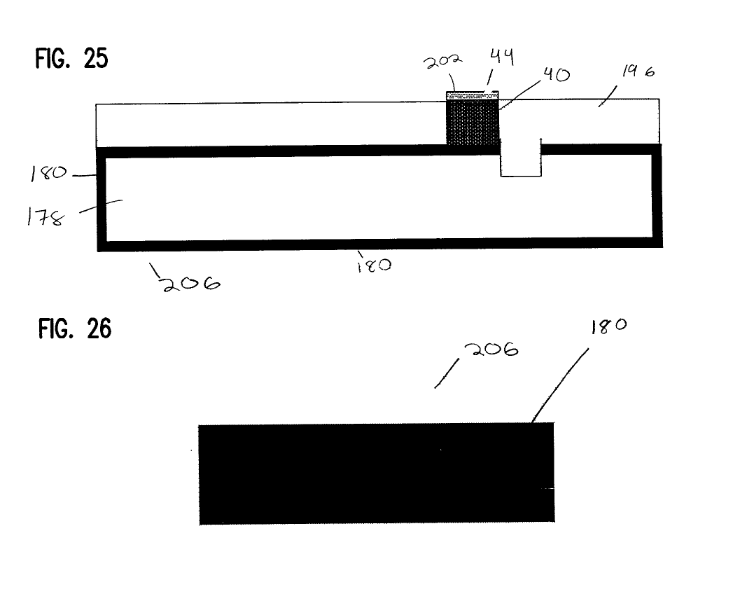

As shown in cross-section at FIG. 23, and in top plan view at FIG. 24, the magnetic material 40 is then covered with a dielectric layer 202, preferably BCB. A seed and adhesion layer (not shown) is then sputtered onto the dielectric layer 202. Next, a photo resist layer (not shown) is applied, patterned and developed for the contact bar. Then, the contact bar portions 44 are plated on the dielectric layer 202. The photo resist layer is then stripped and the seed and adhesion layer is removed by ion milling.

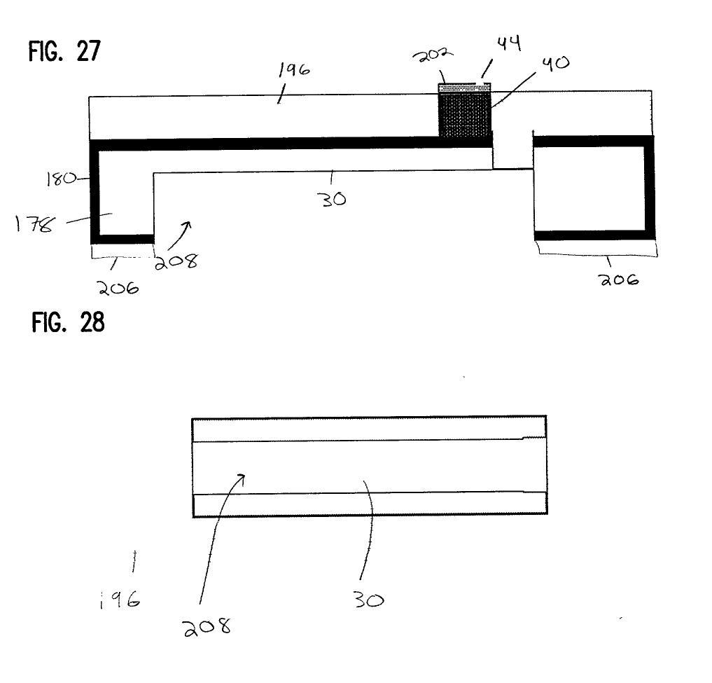

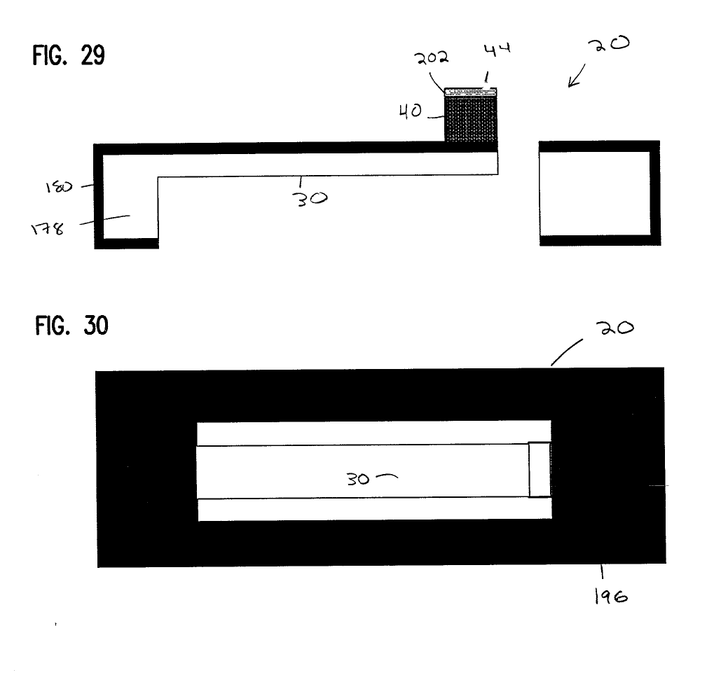

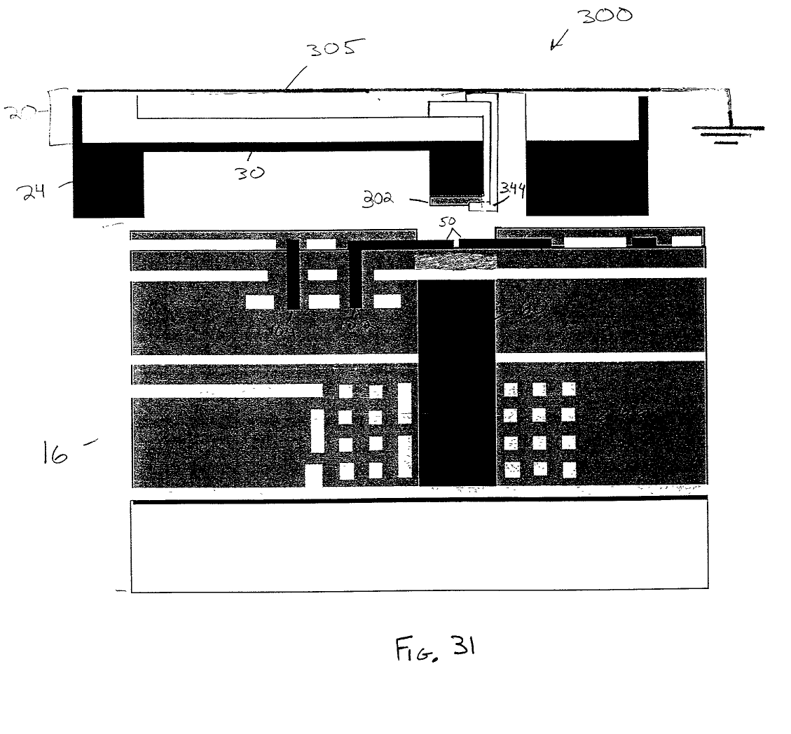

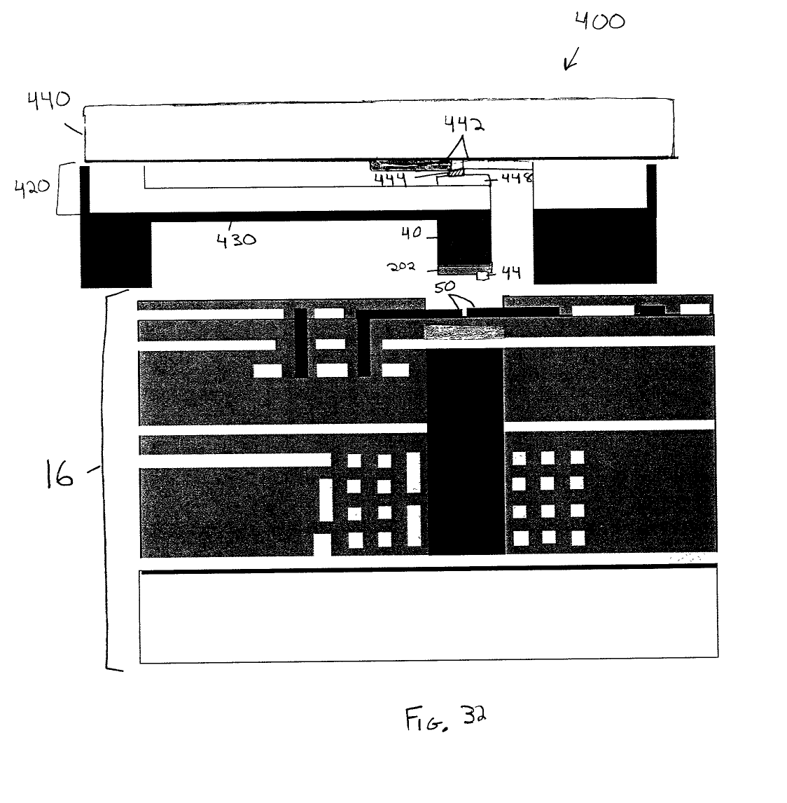

As shown in cross-section view at FIG. 25 and in top plan view at FIG. 26, a protective layer of photo resist 196 is applied to the top surface of the actuator substrate 178. The actuator substrate 178 is then flipped to expose the bottom side where a photo resist layer 206 is applied, patterned and developed on the silicon nitride layer 180. As shown in cross-section at FIG. 27 and in bottom plan view at FIG. 28, etching, such as a KOH etch, is then used to create a trench 208 to release the actuator arm 30. Next, the photo resist layer 196 is removed. The assembled actuator arm portion 20 is shown in cross-section at FIG. 29 and in bottom plan view at FIG. 30.

In the manufacturing method discussed with respect to FIGS. 17-30, a backside etch is used to create a trench 208 that releases the actuator arm 30. Alternatively, it is possible to use a thinner actuator substrate and thereby eliminate the need for a backside etch. The actuator arm created using this type of manufacturing process would be constructed out of the full thickness of the actuator substrate.

Fabrication of the Spacer, Dicing and Assembly

A spacer 24, shown in FIGS. 1-2, will also be fabricated to join the actuator portion 20 to the contacts substrate 16 in one embodiment. Preferably, the spacer is at least approximately 100 micrometers thick; more preferably at least about 150 micrometers thick; and most preferably about 200 micrometers thick. Several different techniques are available for fabricating the spacer 24. In one technique, a silicon wafer is used which may be commercially obtained in the appropriate thickness. An advantage of using a silicon wafer is that the thermal expansion coefficient will match that of a silicon cantilever arm wafer. Holes may be etched in the spacer using a KOH etch before gluing the spacer to the surface of the cantilever portion 20. The spacer is preferably attached to the actuator using techniques that do not require high temperatures because high temperatures may demagnetize the magnet 40, burn the dielectric layer 202 or diffuse the metal in the contact bar 44. For example, adhesive may be used to attach the spacer 24 to the actuator 20.

Preferably, the contacts substrate 16, including the electromagnet, is created on a large substrate portion, such as a 4-inch wafer or a 6-inch wafer, so that many contacts substrates for microrelays are present on the original wafer. After the assembly of the electromagnet portion, the contacts substrate 16 is diced to appropriate smaller portions, such as squares of 0.6 inches by 0.6 inches, or more preferably, 0.7 inches by 0.7 inches. The arm and spacer wafers are diced to slightly smaller proportions to allow room to bond to the bonding pads at the edge of the electromagnet substrate 16.

The actuator 20 and spacer 24 are joined to the contacts substrate 16 to assemble the final package as illustrated in FIG. 1. Adhesive may be used to join the actuator 20 to the spacer 24, as well as other joining techniques. Preferably, the contact bar 44 is spaced from the pair of contacts 50 by at least about 75 micrometers; more preferably at least about 100 micrometers; and most preferably about 150 micrometers. Providing a low contact resistance between the electrical contacts is a primary goal of many microrelays. There is a linear relationship between the force with which the contacts are held together and the contact resistance. Preferably, the microrelay 10 will have a contact resistance for a single contact of less than about 100 milliohm. It is anticipated that the contact bars 44 will be constructed of gold.

The various embodiments described above are provided by way of illustration only and should not be construed to limit the invention. Those skilled in the art will readily recognize various modifications and changes which may be made to the present invention without strictly following the exemplary embodiments and applications illustrated and described herein, and without departing from the true spirit and scope of the present invention which is set forth in the following claims.

What is claimed is:

1. A microrelay device comprising:
a substrate comprising a first pair of contacts, a ferromagnetic material, and a conductive coil surrounding the ferromagnetic material; and
an acutator fixed at a first end and movable at a second end between a first and second position, wherein the actuator includes a permanent magnet and a contact area near the second end, between a first position and a second position, wherein the contact area of the actuator is spaced from the pair of contacts on the substrate in the first position, and wherein the contact area of the actuator is in contact with the first pair of contacts on the substrate in the second position.

2. The microrelay device of claim 1 wherein the conductive coil is configured to selectively modify a local force on the actuator to allow movement of the actuator between the first and second position; and
wherein the permanent magnet provides a latching force to hold the actuator in the second position.

3. The microrelay of claim 2 wherein the actuator is configured so that a deflection force acts to return the actuator device to the first position from the second position.

4. The microrelay of claim 3 wherein the actuator device is configured to move from the first position to the second position when the local magnetic force on the actuator is increased by applying current to the conductive coil in a first direction so that the local magnetic force is greater than the deflection force; and
wherein the actuator device is configured to move from the second position to the first position when the local magnetic force on the actuator is modified by applying current to the conductive coil in a second direction so that the deflection force is greater than an attractive local magnetic force.

5. The microrelay of claim 1 wherein the actuator is maintained in the first position without the application of current to the conductive coil.

6. The microrelay of claim 1 wherein the actuator is maintained in the second position without the application of current to the conductive coil.

7. The microrelay of claim 1 wherein the actuator is maintained in the first and second positions without the application of current to the conductive coil.

8. The microrelay of claim 1 further comprising a ground plane, wherein the contact bar of the actuator contacts the ground plane in the first position.

9. The microrelay of claim 1 further comprising a second substrate including a second pair of contacts, wherein the actuator further comprises a second contact area; wherein the second contact area of the actuator contacts the second pair of contacts when the actuator is in the first position.

10. The microrelay of claim 1 wherein the contact area comprises a conductive material.

11. The microrelay of claim 1 wherein the ferromagnetic material of the substrate is a second permanent magnet.

12. A microrelay device including:
a substrate comprising a ferromagnetic material, a conductive coil imbedded within layers of insulating material, the conductive coil surrounding the ferromagnetic material, and a first pair of contacts on an exposed surface of the substrate, wherein current applied to the conductive coil creates a magnetic field;
an actuator movable between a first and a second position, the actuator comprising a permanent magnet and a contact area for contacting the first pair of contacts when the actuator is in the second position;
wherein a deflection force acts to return the actuator to the first position from the second position.

13. The microrelay of claim 12 wherein the actuator is fixed at a first end and movable at a second end.

14. The microrelay of claim 12 wherein the actuator is maintained in the first position without the application of current to the conductive coil.

15. The microrelay of claim 12 wherein the actuator is maintained in the second position without the application of current to the conductive coil.

16. The microrelay of claim 12 wherein the actuator is maintained in the first and second positions without the application of current to the conductive coil.

17. The microrelay of claim 12 wherein the ferromagnetic material of the actuator is a second permanent magnet.

18. A method of fabricating a microrelay comprising:
(a) constructing an electromagnetic substrate including the steps of:
(i) forming a conductive coil, a current control line and a current return line embedded in an insulating material;
(ii) etching away the insulating material in a center area of the coil;
(iii) placing a ferromagnetic material within the center area;
(iv) creating contact lines on an exposed surface of the substrate;
(b) attaching an actuator beam structure to the electromagnetic substrate, where the actuator includes a permanent magnet and a conductive contact area near a second end of the actuator, wherein the second end is movable between a first position spaced from the contact lines and a second position contacting the contact lines.

19. The method of claim 18 wherein the step of placing the ferromagnetic material in the center area comprises mixing a hard magnetic powder with epoxy and depositing the mixture in the center area.

20. The method of claim 18 wherein the step of placing the ferromagnetic material in the center area comprises electroplating a magnetic material.
